(19) United States
(12) Patent Application Publication
(10) Pub. No.: US 2009/0067603 A1
(43) Pub. Date: Mar. 12, 2009

(54) Pre-arranged, mutually agreed to, VoIP or VoIM call

(75) Inventor: David S. Mohler, Arvada, CO (US)

Correspondence Address: COHEN, PONTANI, LIEBERMAN & PAVANE, 551 FIFTH AVENUE, SUITE 1210, NEW YORK, NY, 10176, US

(73) Assignee: Avaya Technology LLC

(21) Appl. No.: 11/899,884

(22) Filed: Sep. 7, 2007

(51) Int. Cl. H04M 3/56

(52) U.S. Cl. 379/202.01

(57) ABSTRACT

Presented is a method for pre-arranging a VoIP or VoIM phone call. A first date and time for the VoIP or VoIM phone call and participants for the VoIP or VoIM phone call is selected. The availability of the participants during the first date and time is determined. If any of the participants are unavailable, one or more subsequent dates and times are selected. An invitation for the VoIP or VoIM phone call is then transmitted. Acceptance of the invitation is then received from the participants thereby indicating that the date and time has been agreed to. After the acceptance is received, the participants' location and contact information for the agreed date and time are obtained. On the agreed upon date and time, the VoIP or VoIM phone call is automatically routed to the participants' respective locations and the call is automatically established without any involvement from the participants.

### BACKGROUND OF THE INVENTION

1. Field of the Invention

The present invention relates generally to IP telephone calls, and more particularly to a system and method for pre-arranging a date and a time for a Voice over Internet Protocol (VoIP) or a Voice over Instant Messenger (VoIM) phone call that is agreed to by all participants.

2. Description of the Related Art

Typically, when arranging a VoIP or VoIM call, the individual initiating the call will attempt to contact the other parties without pre-arranging the call. As with traditional telephony, such a method may, or may not, result in successful communications. More advanced Internet Protocol (IP) conference bridges exist where all participants call and connect to a communication bridge at a pre-arranged time. This can provide an improvement on a call that is not pre-arranged and results in a higher probability of success. There have been attempts to address the many issues involved with arranging VoIP or VoIM calls, such as call set-up, time zone synchronization, and message status, for example. However, none of the existing VoIP or peer-to-peer software applications, such as SKYPE or Gizmo, for example, provide completely integrated mutually agreed to (by the participants) call scheduling, call execution (i.e., call launching), and call forwarding features. Further, none of the existing peer-to-peer or VoIP software applications correctly factors in call/appointment variables such as date, time, availability of the participants, locations of participants, time zone differences, and IP devices used by participants, for example. Although there exists software that can detect the presence of a VoIP called party that can be overlaid on the VoIP or VoIM call, none of the existing software addresses scheduling mutually agreed to VoIP or VoIM phone calls.

With applications such as SKYPE or Gizmo, there is also a problem with determining the availability of another SKYPE or Gizmo user. A caller can call a party in real time with the potential of not reaching the party. A caller can use a service such as VoSky where a pseudo call center is set up that can forward missed calls to other numbers or to voicemail. If a call was missed, a caller can send an email to the called party with the topic and details specifying a SKYPE or Gizmo call for a future date and then set the date in Outlook or other scheduler once the called party responds. However, none of these approaches ensures that the caller will connect with the called party at the desired time and date.

An Artificial Intelligence Voice Multimedia System will allow a calling party to set a single-ended SKYPE or Gizmo reservation, but does not allow a user to pre-arrange a call with each party's consent in advance.

### SUMMARY OF THE INVENTION

In one aspect, the invention involves a method for pre-arranging a Voice over Internet Protocol (VoIP) or Voice over Instant Message (VoIM) phone call. The method includes selecting, by a caller, a first date and time for the VoIP or VoIM phone call and at least one called party for the VoIP or VoIM phone call, determining if the at least one called party is available during the first date and time, and if not, selecting, by the caller, one or more subsequent dates and times for the VoIP or VoIM phone call, and transmitting to the at least one called party an invitation for the VoIP or VoIM phone call comprising the first date and time or one of the one or more subsequent dates and times. The method further includes receiving from the at least one called party an acceptance of the invitation thereby indicating that the date and time has been agreed to by the at least one called party and the caller, and after receiving the acceptance of the invitation, obtaining the location and contact information for the at least one called party and the caller for the agreed date and time for the VoIP or VoIM phone call, and on the agreed upon date and time, automatically routing the VoIP or VoIM phone call to the locations of the at least one called party and the caller and thereby automatically establishing the VoIP or VoIM phone call without any involvement from the at least one called party or the caller.

In one embodiment, the method further includes entering the first date and time and the called party's contact information into a VoIP scheduling application graphical user interface.

In another embodiment, determining if the at least one called party is available during the first initial date and time comprises accessing a communication network accessible schedule program for the at least one intended participant.

In still another embodiment, after receiving the acceptance of the invitation from the at least one called party, the method further includes adding the agreed upon date and time to the communication network accessible schedule program for the at least one called party and adding the agreed upon date and time to a communication network accessible schedule program for the caller.

In still other embodiments, obtaining the location and contact information of the at least one called party and caller comprises accessing a communication network accessible contact database for the at least one intended participant and accessing a communication network accessible contact database for the caller.

In yet another embodiment, before receiving from the at least one called party an acceptance of the invitation, the method further includes receiving from the at least one called party an alternative date and time for the VoIP or VoIM phone call.

In still another embodiment, in response to the alternative date and time, the method further includes transmitting an updated invitation if the caller agrees to the alternative date and time.

In other embodiments, routing the VoIP or VoIM phone call to the at least one called party's location comprises routing the VoIP or VoIM phone call to an internet protocol (IP) device of the least one intended participant.

In still other embodiments, the method further includes configuring, by the caller the VoIP or VoIM call, to have a pre-set time limit, configuring, by the caller the VoIP or VoIM call, to have a pre-set time limit with an option to extend the call, or configuring, by the caller the VoIP or VoIM call, to have an open-ended time limit.

In another aspect, the invention involves a system for pre-arranging a Voice over Internet Protocol (VoIP) or Voice over Instant Message (VoIM) phone call. The system includes means for selecting, by a caller, a first date and time for the VoIP or VoIM phone call and at least one called party for the VoIP or VoIM phone call, means for determining if the at least one called party is available during the first date and time, and if not, selecting, by the caller, one or more subsequent dates and times for the VoIP or VoIM phone call, and means for transmitting to the at least one called party an invitation for the VoIP or VoIM phone call comprising the first date and time or one of the one or more subsequent dates and times. The system further includes means for receiving from the at least one called party an acceptance of the invitation thereby indicating that the date and time has been agreed to by the at least one called party and the caller, means for after receiving the acceptance of the invitation, obtaining the location and contact information for the called party at least one called party and the caller for the agreed date and time for the VoIP or VoIM phone call, means for automatically routing the VoIP or VoIM phone call to the at least one called party and the caller on the agreed upon date and time, and means for automatically establishing the VoIP or VoIM phone call without any involvement from the at least one called party or the caller on the agreed upon date and time.

In one embodiment, the system further includes a graphical user interface for entering the first date and time and the at least one called party's contact information.

In another embodiment, the means for determining if the at least one called party is available during the first date and time includes means for accessing a communication network accessible schedule program for the at least one called party.

In still another embodiment, the system further includes means for adding the agreed upon date and time to the communication network accessible schedule program for the at least one called party and means for adding the agreed upon date and time to a communication network accessible schedule program for the caller after receiving the acceptance of the invitation from the at least one called party.

In yet another embodiment, the means for obtaining the location and contact information of the at least one called party and caller includes means for accessing a communication network accessible contact database for the at least one called party and means for accessing a communication network accessible contact database for the caller.

In another embodiment, the system further includes means for receiving from the at least one called party an alternative date and time for the VoIP or VoIM phone call before receiving from the at least one called party an acceptance of the invitation.

In still another embodiment, the system further includes means for transmitting an updated invitation if the caller agrees to the alternative date and time in response to the alternative date and time.

In other embodiments, the means for routing the VoIP or VoIM phone call to the at least one called party's location includes means for routing the VoIP or VoIM phone call to an internet protocol (IP) device of the least one intended participant.

In another embodiment, the system further includes means for configuring, by the caller, the VoIP or VoIM call to have a pre-set time

In yet another embodiment, the system further includes means for configuring, by the caller, the VoIP or VoIM call to have a pre-set time limit with an option to extend the call.

In still another embodiment, the system further includes means for configuring, by the caller, the VoIP or VoIM call to have an open-ended time limit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

In the drawings, wherein like reference characters refer to the same parts throughout the different views:

FIG. 1 is an illustrative flow diagram of a prior art method for scheduling and establishing a VoIP phone call;

FIG. 2 is an illustrative block diagram of a plurality of computers in communication with a communication network and employing the system and method for pre-arranging a date and a time for a VoIP or a VoIM phone call, according to one embodiment of the invention; and

FIG. 3 is an illustrative flow diagram of a method for pre-arranging a date and a time for a VoIP or a VoIM phone call, according to one embodiment of the invention.

### DETAILED DESCRIPTION OF THE PRESENTLY PREFERRED EMBODIMENTS

The present invention involves a system and method for pre-arranging a date and a time for a Voice over Internet Protocol (VoIP) or a Voice over Instant Message (VoIM) phone call that is mutually agreed to by all participants. The system and method of the present invention applies generically to VoIP, VoIM, and peer-to-peer phone calls and more specifically to applications such as SKYPE or Gizmo. The system and method of the present invention can also apply to various other call modalities such as WiFi, BroadVoice, Net2Phone, or Packet8, for example.

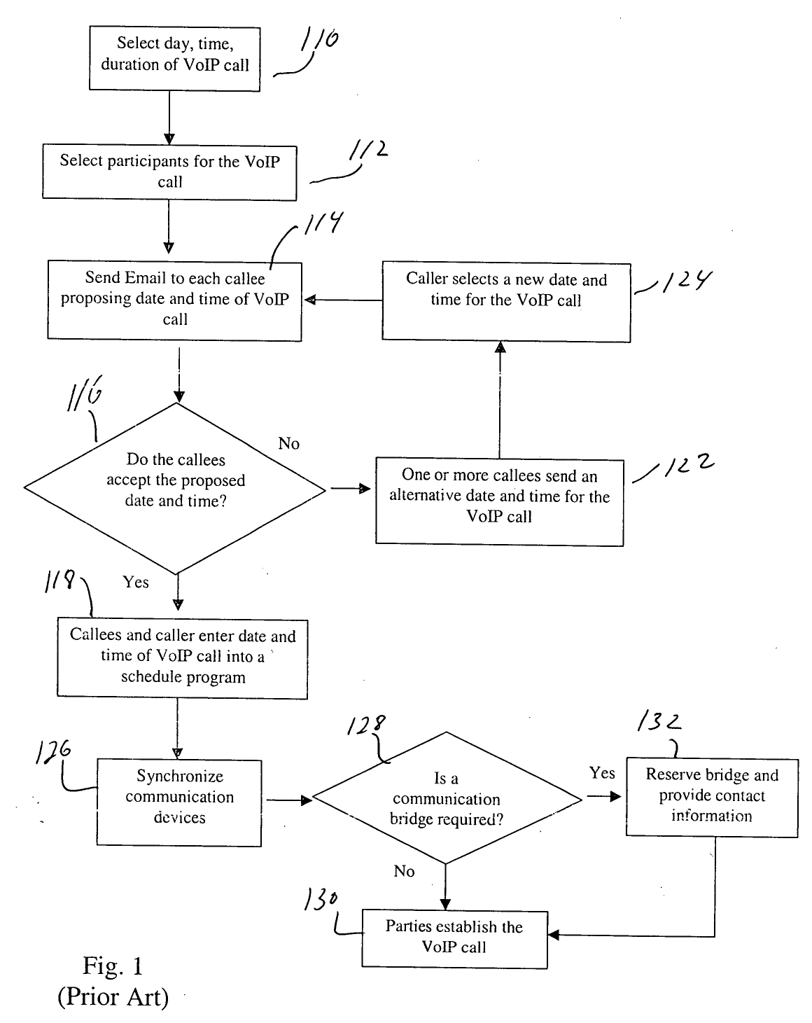

Referring to FIG. 1, an illustrative flow diagram of a prior art method for scheduling and establishing a VoIP phone call is shown. During the VoIP or VoIM call arranging process, several emails are typically sent back and forth between the intended participants to arrange a mutually acceptable date and time. Thereafter, the actual call is made. With existing methods of establishing a VoIP or VoIM phone call, the person initiating the call doesn't have the option of ringing a physical location, getting someone live to alert the called party that the caller has called. In some instances, the caller can leave a voice mail message when the called party is unavailable, but only if the called party's computer includes the proper application and is configured to receive and store voice mail messages. In essence, all the intended parties have to be present at the exact time the VoIP or VoIM call is established to connect in real time with each other. Although methods for detecting the presence of an IP caller are known in the art, if a called party is not actually present, there is still no way to establish contact with the called party.

According to the prior art method, when a caller wants to schedule a VoIP or a VoIM phone call, the caller picks a time and date for the intended call (step 110). The caller then selects one or more participants (“called parties”) that he wishes to arrange the VoIP call with (step 112). The caller then sends an email to all called parties proposing a date and time for the VoIP call (step 114). Each called party must respond via email with an acceptance of the proposed date or a counter proposal (step 116). If each called party accepts the originally proposed date and time, each called party and the caller must manually enter the date and time of VoIP call in a schedule program (118). If any of the called parties respond with a counter proposal (step 120), the caller selects a new date and time (122) and sends an email reply to the called party and to all the other called parties with the new proposed date and time (step 124). Steps 110 to 116 and 124 continue until a date and time for the VoIP call is agreed upon. This iterative process can result in many emails and schedule proposals before a communication session is agreed upon by all the parties involved.

After the date and time for the VoIP call have been agreed upon, the caller and the called parties must synchronize their communication devices (e.g., desktop computers, laptop computers, PDAs, etc.) (step 126). The caller must then determine if a communication bridge is needed to establish the VoIP call (step 128). If no communication bridge is required, the participants establish the VoIP call using time-division multiplexing (TDM) and/or IP phones (soft phones or hard phones) (step 130). If a communication bridge is needed to establish the VoIP call, the caller reserves the communication bridge and provides the required contact information (step 132).

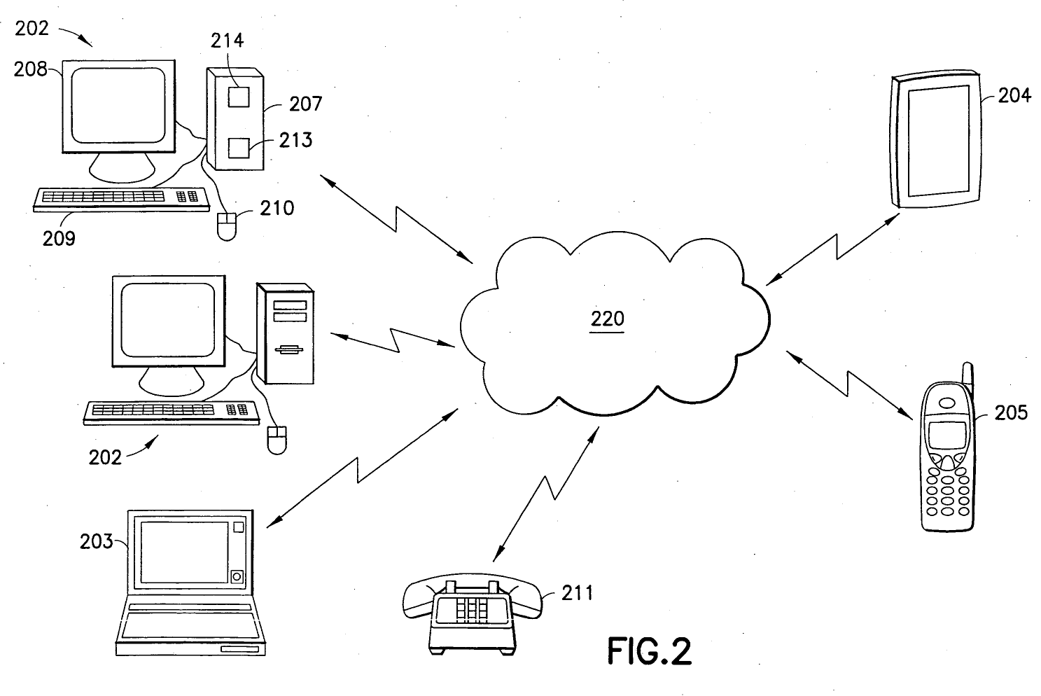

FIG. 2 is an illustrative block diagram of a plurality of computer systems 202, 203, a personal data assistant (PDA) 204, an IP hard phone 211, and a cell phone 205 in communication with a communication network 220 and employing the method for pre-arranging a date and a time for a VoIP or a VoIM phone call in accordance with an embodiment of the present invention.

The computer system 202 is a desktop computer system that includes a CPU 207, which includes a processor 214 and memory 213, a monitor 208, a keyboard 209, a mouse 210 (or other input device), an IP phone and a wired or wireless connection to the communication network 220. The computer system 203 may be a laptop computer that includes a CPU, a memory, and a wired or wireless connection to the communication network 220. The computer systems 202 and 203, in one embodiment each include an IP soft phone application stored in memory that is executed by the CPU. The PDA 204 includes a CPU, memory, and a cellular phone feature, WLAN, and/or Bluetooth functionality to provide wireless connectivity to the communication network 220. The cell phone 205 includes a CPU, memory, and WLAN, and/or Bluetooth functionality to provide wireless connectivity to the communication network 220. The IP hardphone 211 includes a CPU, memory, WLAN, and/or Bluetooth functionality to provide wireless connectivity to the communication network 220.

The computer systems 202, 203, PDA 204, cell phone 205 and, IP hard phone 211, each include (stored in memory) and execute (via the CPU) a email/schedule program such as Microsoft™ Outlook™, or other similar email and schedule programs, a personal contact information database, and a VoIP, VoIM, or peer-to-peer application. Further, the computer systems 202, 203, PDA 204, cell phone 205, and IP hard phone 211, each include (stored in memory) and execute (via the CPU) a program/software application (“VoIP scheduling application”) for pre-arranging a date and a time for a VoIP or a VoIM phone call, which is discussed in further detail below.

The VoIP scheduling application is software/programming language and operating system agnostic. In one embodiment, the VoIP scheduling application uses Session Initiation Protocol (SIP) or other protocols to perform the handshake between the parties while negotiating a pre-determined time, date, and other communication session specifics. The VoIP scheduling application is also IP telephony agnostic to the extent that IP hard phones and IP soft phones can both employ the VoIP scheduling application. However, if the communication session is protocol specific, a common protocol supported between the call endpoints becomes another matter of negotiation prior to the communication session. Interfaces with existing email, scheduler, and/or presence information can be handled with appropriate software plug-ins to the VoIP application that are known to those skilled in the art. The VoIP scheduling application is extensible to Server Oriented Architectures by using appropriate software plug-ins to speak Oasis Business Process Execution Language (BPEL) or other Service Oriented Architecture (SOA) languages.

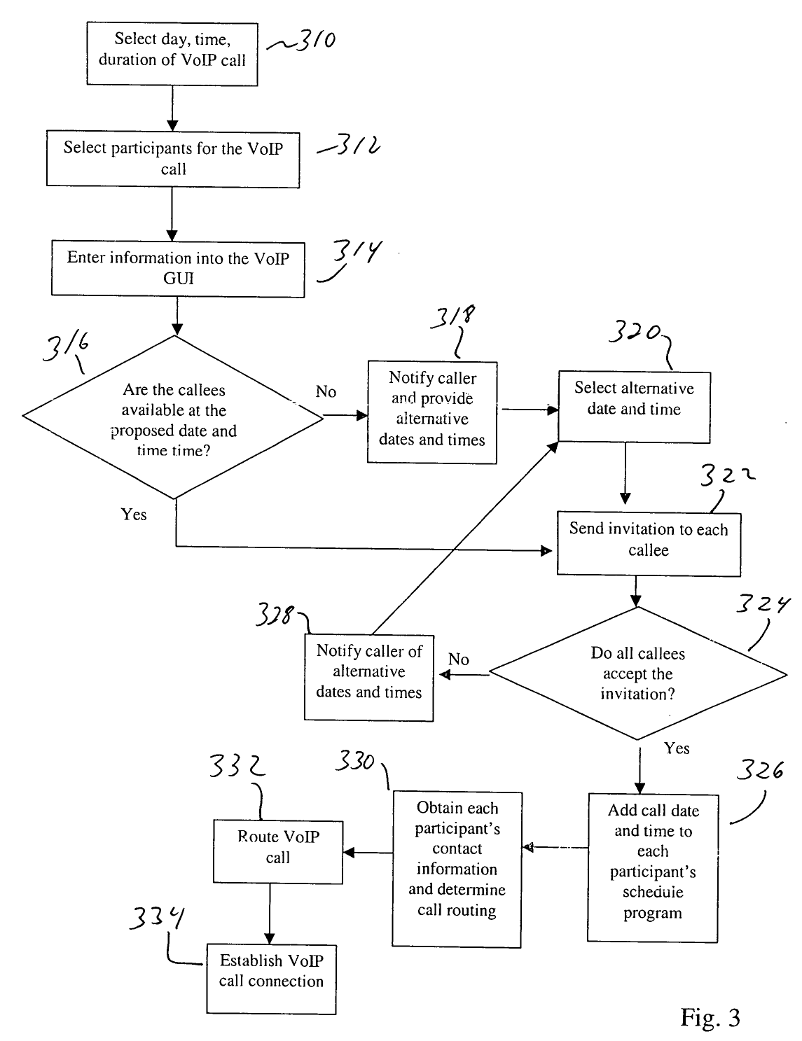

FIG. 3 shows an illustrative flow diagram of a method, according to one embodiment, for pre-arranging a date and a time for a VoIP or a VoIM phone call. As stated above, the VoIP scheduling application is stored in the memory of the operating desktop, laptop, or PDA and executed by the resident CPU.

In one embodiment, the VoIP scheduling application seamlessly integrates or interfaces with a third party email and schedule programs, and retrieves contact information from a third party contact database program. In another embodiment, the VoIP scheduling application includes integrated email, schedule, and contact database programs, which is important for mobile devices where application program efficiency is a concern. The VoIP scheduling application also interfaces with the resident VoIP, VoIM, or peer-to-peer application, such as SKYPE, Gizmo, or other VoIP telephony program, for example. In one embodiment, the VoIP scheduling application includes a graphical user interface (GUI), which the caller uses to arrange a VoIP or VoIM call.

When a caller wants to schedule a VoIP or a VoIM phone call, the caller selects a time and date for the intended call (step 310). The caller then selects one or more participants (“called parties”) for the call (step 312). The caller configures the VoIP call by entering the time, date, and called party contact information into the VoIP scheduling application GUI (step 314). The VoIP scheduling application accesses each called party's scheduling program (over the communication network 120) to determine if the proposed date/time is available for each called party (step 316). This is preferably transparent to the called party (i.e., the called party is not aware that the calendar is being checked). Depending on the relationship between the caller and the called party, various levels of disclosure of availability may be appropriate. For example, for co-workers with an enterprise disclosure of the whereabouts of the party on a given day may not be viewed as a security issue. On the other hand, a call between two acquaintances may only show the time as available or not, rather than provide additional disclosure. Determination of what level of disclosure is permitted can be an administered feature and be subject to company security and Virtual Private Network (VPN) type rules. The level of access that the VoIP scheduling application has to the called party's scheduling program is dependent upon the application, the firewall, VPN, or other security. The scheduling request is received and is authenticated against the VPN for enterprise contacts, or against trusted sources in the case of an individual. If the request for schedule information is neither approved by the VPN nor within the users trusted contacts, a request for access that would have to be pre-approved by the called parties would be needed prior to the handshake. An alternative is to make schedule access open to the world, but with no indication of the event or location, and provide only an indication that the party is available or not.

As previously described, the called party's scheduling program can be either an external third party schedule program that interfaces with the VoIP scheduling application, or a schedule program that is integrated with the VoIP scheduling application.

It should be noted that the VoIP scheduling application, when examining the schedules of the various called parties to determine when a VoIP call can be scheduled, takes into account time zone differences, established work week limitations, holidays, and variations in computer clocks using systems and methods that are described in U.S. Pat. Nos. 5,434,908; 6,175,859; 6,763,020; and U.S. Patent Publication No. 2004/0136274, the entirety of which are incorporated herein by reference.

If any of the called parties are not available at the proposed date and time, the VoIP scheduling application notifies the caller (via the VoIP scheduling application GUI) and provides the caller with alternative dates and times based on the various called parties' schedules (step 318). The caller then selects an alternative date and time (step 320). If the called parties' schedules are open during the date and time initially proposed by the caller, or the caller selects an alternative date and time, the VoIP scheduling application sends an invitation for the VoIP call to each called party (step 322). The VoIP scheduling application waits for each called party to accept the invitation or propose an alternative date and time (step 324). If each called party accepts the invitation for the VoIP call, the VoIP scheduling application adds an entry in each called party's schedule program and the caller's schedule program indicating the date and time that the VoIP call is scheduled (step 326).

On the called party side, when a proposed VoIP call date and time is sent by the caller, the called party receives an invitation from the caller. As explained above, the invitation is only sent if the called party's schedule does not contain an appointment which conflicts with the date/time of the caller's request. In one embodiment, the invitation is in the form of a pop-up message dialog box that includes an “accept” and a “decline” button. If the called party selects (e.g., clicks with a mouse, etc.) the “accept” button the VoIP scheduling application adds an entry into the called party's schedule. The called party will be provided with a reminder as the date and time for the VoIP call approaches. If the called party presses the “decline” button, the called party is presented with another pop-up dialog box, which allows the called party to enter an alternative date and time. The called party would then press a “send” button to transmit the alternative date and time back to the caller.

In another embodiment, the pop-up message also includes a “remind” button. If the called party presses the “remind” button, the pop-up message will disappear for a pre-determined time and reappear after the pre-determined time has elapsed. This feature allows the called party to consult his schedule to determine if he will be available on the proposed date and time and respond to the invitation at a later time.

Still referring to FIG. 3, if one or more called parties propose an alternative date and time, VoIP scheduling application notifies the caller of the alternative proposal (step 328). The caller then either accepts the new proposal or makes a counter proposal (step 320) and sends a new invitation to each called; party (step 322). Steps 310 to 322 and 328 are repeated until a date and time is set for the VoIP call. In another embodiment, the date and time proposals and counter proposals can be accomplished via email.

When the date and time for the call arrives, the VoIP scheduling application accesses each called party's schedule and contact information (from the called party's contact information database) and determines if each of the called party's is still available, where each called party is located (e.g., office, home, traveling) and determines where the call needs to be routed (step 330). For example, one called party may have originally been scheduled to be in his office at the time of the VoIP call, but has had a change in plans and is now traveling. The out of the office status of the called party can be reflected in a calendar entry on the called party's computer, for example, which indicates that the called party is presently traveling. This information will be used by the method such that the method will obtain the called party's cell phone number from the called party's contact information database and establish the VoIP call with the called party via his cell phone 205 (FIG. 2), rather than via his/her office computer 202. The VoIP scheduling application then automatically routs the VoIP call appropriately for each called party and the caller (step 332), and automatically establishes the VoIP phone call connection (step 334). Thus, there is no user (caller or called party) involvement after the date and time for the VoIP call has been accepted by all of the participants.

In one embodiment, the VoIP call can have a pre-set time limit. In another embodiment, the VoIP call can have a pre-set time limit with an option to extend the call. In still another embodiment, the VoIP call can be open-ended.

In other embodiments, various participants can be scheduled to join and leave the VoIP call at various times. For example, a CEO (caller) may need to speak with three different managers (called party's) regarding various topics. The VoIP phone call could be arranged such that the VoIP call starts with the participants being the CEO, a first manager, and a second manager to discuss a first topic. After a pre-scheduled amount of time (i.e., the time to discuss the first topic), the first manager signs off and the VoIP phone meeting continues with only the CEO and the second manager participating and discussing a second topic. After a pre-scheduled amount of time (i.e., the time to discuss the second topic), the third manager joins the VoIP call to discuss a third topic.

During the conference call if one party wants to have a private discussion with another, a so-called “sidebar” can be implemented wherein the non-side-bar participants will be temporarily blocked from listening in or otherwise participating on the call. In operation, one or more new IP communication sessions are set up for the various sidebars, and participants have the ability to switch between the sidebar and the original or main discussion as needed or desired.

In another embodiment, the VoIP scheduling application includes a “time-slide” feature. This feature allows for dynamic real-time adjustment of the call time. The time slide feature must be negotiated at the time of the decision by the participants to extend the time of the call. In an open ended case, time for the participants and the resources would need to be blocked out beyond the anticipated duration. In the case of a time-slide, SIP messages would need to be generated to reserve the resources and modify the participants' schedules. If the participants have smart schedulers or so called Intelligent Personal Assistants, the extension can spawn meeting change requests and the like to free up the amount of time to close on the discussion. The request to extend can either be handled verbally, or with an extend by an “x” (agreed to) amount of time request launched by the caller via the GUI.

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A method for pre-arranging a Voice over Internet Protocol (VoIP) or Voice over Instant Message (VoIM) phone call, comprising:
selecting, by a caller, a first date and time for the VoIP or VoIM phone call and at least one called party for the VoIP or VoIM phone call;
determining if the at least one called party is available during the first date and time, and if not, selecting, by the caller, one or more subsequent dates and times for the VoIP or VoIM phone call;
transmitting to the at least one called party an invitation for the VoIP or VoIM phone call comprising the first date and time or one of the one or more subsequent dates and times;
receiving from the at least one called party an acceptance of the invitation thereby indicating that the date and time has been agreed to by the at least one called party and the caller;
after receiving the acceptance of the invitation, obtaining the location and contact information for the at least one called party and the caller for the agreed date and time for the VoIP or VoIM phone call; and
on the agreed upon date and time, automatically routing the VoIP or VoIM phone call to the locations of the at least one called party and the caller and automatically establishing the VoIP or VoIM phone call without any involvement from the at least one called party or the caller.

2. The method according to claim 1, further comprising entering the first date and time and the called party's contact information into a VoIP scheduling application graphical user interface.

3. The method according to claim 1, wherein determining if the at least one called party is available during the first date and time comprises accessing a communication network accessible schedule program for the at least one called party.

4. The method according to claim 1, further comprising after receiving the acceptance of the invitation from the at least one called party, adding the agreed upon date and time to the communication network accessible schedule program for the at least one called party and adding the agreed upon date and time to a communication network accessible schedule program for the caller.

5. The method according to claim 1, wherein obtaining the location and contact information of the at least one called party and caller comprises accessing a communication network accessible contact database for the at least one participant and accessing a communication network accessible contact database for the caller.

6. The method according to claim 1, further comprising before receiving from the at least one called party an acceptance of the invitation, receiving from the at least one called party an alternative date and time for the VoIP or VoIM phone call.

7. The method according to claim 6, further comprising in response to the alternative date and time, transmitting an updated invitation if the caller agrees to the alternative date and time.

8. The method according to claim 1, wherein routing the VoIP or VoIM phone call to the at least one called party's location comprises routing the VoIP or VoIM phone call to the an internet protocol (IP) device of the least one called party.

9. The method according to claim 1, further comprising configuring, by the caller, the VoIP or VoIM call to have a pre-set time limit.

10. The method according to claim 1, further comprising configuring, by the caller, the VoIP or VoIM call to have a pre-set time limit with an option to extend the call.

11. The method according to claim 1, further comprising configuring, by the caller, the VoIP or VoIM call to have an open-ended time limit.

12. A system for pre-arranging a Voice over Internet Protocol (VoIP) or Voice over Instant Message (VoIM) phone call, comprising:
means for selecting, by a caller, a first date and time for the VoIP or VoIM phone call and at least one called party for the VoIP or VoIM phone call;
means for determining if the at least one called party is available during the first date and time, and if not, selecting, by the caller, one or more subsequent dates and times for the VoIP or VoIM phone call;
means for transmitting to the at least one called party an invitation for the VoIP or VoIM phone call comprising the first date and time or one of the one or more dates and times;
means for receiving from the at least one called party an acceptance of the invitation thereby indicating that the date and time has been agreed to by the at least one called party and the caller;
means for obtaining the location and contact information for the at least one called party and the caller for the agreed date and time for the VoIP or VoIM phone call after receiving the acceptance of the invitation;
means for automatically routing the VoIP or VoIM phone call to the at least one called party and the caller on the agreed upon date and time; and
means for automatically establishing the VoIP or VoIM phone call without any involvement from the at least one called party or the caller on the agreed upon date and time.

13. The system according to claim 12, further comprising a graphical user interface for entering the first date and time and the at least one called party's contact information.

14. The system according to claim 12, wherein the means for determining if the at least one called party is available during the first date and time comprises means for accessing a communication network accessible schedule program for the at least one called party.

15. The system according to claim 12, further comprising means for adding the agreed upon date and time to the communication network accessible schedule program for the at least one called party and means for adding the agreed upon date and time to a communication network accessible schedule program for the caller after receiving the acceptance of the invitation from the at least one called party.

16. The system according to claim 12, wherein the means for obtaining the location and contact information of the at least one called party and caller comprises means for accessing a communication network accessible contact database for the at least one called party and means for accessing a communication network accessible contact database for the caller.

17. The system according to claim 12, further comprising means for receiving from the at least one called party an alternative date and time for the VoIP or VoIM phone call before receiving from the at least one called party an acceptance of the invitation.

18. The system according to claim 17, further comprising means for transmitting an updated invitation if the caller agrees to the alternative date and time in response to the alternative date and time.

19. The system according to claim 12, wherein the means for routing the VoIP or VoIM phone call to the at least one called party's location comprises means for routing the VoIP or VoIM phone call to an internet protocol (IP) device of the least one intended participant.

20. The system according to claim 12, further comprising means for configuring, by the caller, the VoIP or VoIM call to have a pre-set time limit.

21. The system according to claim 12, further comprising means for configuring, by the caller, the VoIP or VoIM call to have a pre-set time limit with an option to extend the call.

22. The system according to claim 12, further comprising means for configuring, by the caller, the VoIP or VoIM call to have an open-ended time limit.
